(19) United States
(12) Patent Application Publication
(10) Pub. No.: US 2012/0042489 A1
(43) Pub. Date: Feb. 23, 2012

(54) Cinerary casket arrangement system

(76) Inventor: Renhui Cai, Xiamen (CN)

(21) Appl. No.: 11/654,230

(22) Filed: Jan. 16, 2007

(51) Int. Cl. A61G 17/00

(52) U.S. Cl. 27/35

(57) ABSTRACT

A cinerary casket arrangement system providing solid, light, and compact construction and attractive appearance to allow easy packaging, transportation, installation, and use is comprised of base, sideboard, top, lateral shelf, vertical partitioning board, lateral partitioning board, and door panel; sideboard being fixed to the top and the base; multiple sub-racks being formed by having vertical partitioning board abutted to lateral partitioning board by means of insertion slot disposed on each partitioning board; the bottom edge and the top edge of each partitioning board being respectively fixed to the base, the lateral shelf or the top.

### BACKGROUND OF THE INVENTION

(a) Field of the Invention

The present invention is related to a cinerary casket arrangement system.

(b) Description of the Prior Art

A cinerary casket arrangement system for allowing storage of multiple cinerary caskets has become popular since it saves space when compared to that needed in the storage of tombstones or similar products at cemeteries or funeral parlors. As illustrated in FIG. 1 of the accompanying drawings, a cinerary casket arrangement system generally available in the market is comprised of a base 1 (the foundation), two side panels 2 (sidewalls), a top 3 (lid), multiple vertical panels 5, multiple shelves (not illustrated), and a door panel 7.

Whereas the traditional cinerary casket arrangement system is usually made in an integrated part by pouring the cement into a mold; this type of construction is blamed for many flaws including complicated process, production difficulties, rough surfaces, dull appearance, clumsy, and prevented from easy packaging, transportation, installation, and use. Taking the door panel 7 for example, it has two layers. The outer layer of the door panel 7 is a full piece; and when the outer layer is opened, all the sub-racks of the arrangement system are in sight. The inner layer relates to a smaller but thick and heavy panel disposed at the door of the sub-racks. Accordingly, the door panel 7 makes the access very difficult since both layers of the door panel must be respectively opened. Besides the access to any sub-rack would be made at the cost of the privacy of other sub-racks.

An improved version of the traditional cinerary casket arrangement system has been introduced, wherein each sub-rack is made of independent partitioning boards and glued to another sub-rack for easier process to build up and looks delicate and beautiful. Even so, thicker partitioning boards are needed to provide structural stability, bearing capacity and easy adhesion. That is, the improved version of the cinerary casket arrangement system remains heavy and prevents easy packaging, transportation, installation, and use. Since the design of the double-deck door panel 7 is reserved, problems of inconvenient access and poor privacy stay.

### SUMMARY OF THE INVENTION

The primary purpose of the present invention is to provide an improved arrangement system for cinerary casket that is solid and reliable in construction and permits easier packaging, transportation, installation, and use.

To achieve the purpose, an improved structure of a cinerary casket arrangement system of the present invention is comprised of a base, two sideboards, a top, multiple lateral shelves, multiple vertical portioning boards, multiple lateral partitioning boards, and multiple door panels. Wherein, the sideboard is fixed to the base and the top; a slot is cut approximately half way at the middle of each vertical partitioning board and multiple similar slots are cut on the lateral partitioning board for multiple vertical partitioning boards to abut to the lateral portioning board by interesting their slots into their corresponding slots on the lateral partitioning board to form multiple sub-racks. The arrangement system contains multiple layers with each layer comprised of a lateral partitioning board and multiple vertical partitioning boards. The bottom and top edges of the lateral partitioning board and each of the vertical partitioning boards are respectively fixed to the base, the lateral shelf or the top depending on the location of the layer in the arrangement system.

Another purpose of the present invention is to provide an improved arrangement system for cinerary casket that allows convenient access and excellent privacy.

To achieve the purpose, an improved structure of a cinerary casket arrangement system of the present invention is comprised of a base, two sideboards, a top, multiple lateral shelves, multiple vertical portioning boards, a backboard, and multiple door panels. Wherein, the backboard is fixed to both sideboards, the base, and the top; both sides boards are fixed to the top and the base; multiple slots are cut approximately half way at the middle of each vertical partitioning board and each lateral shelf, thus for those vertical partitioning boards to abut to the lateral shelf by interesting slots into their corresponding slots on the lateral shelf to form multiple sub-racks. The top and the bottom edges of those vertical partitioning boards on each layer are respectively fixed to the base and the top while edges of both shorter sides of the lateral shelf of each layer is fixed to the sideboard.

The top, the base, and the sideboards are fixed to one another with studs and pinholes.

Pinholes are disposed on each sideboard and the base at where they are fixed to each other. Both ends of the stud are applied with glue to stick the stud to its corresponding pinholes to fix the sideboard and the base to each other.

Pinholes are disposed on each sideboard and the top at where they are fixed to each other. Both ends of the stud are applied with glue to stick the stud to its corresponding pinholes to fix the sideboard and the top to each other.

A door panel is provided to each sub-rack. Multiple insertions holes are disposed on each door panel in relation to each sub-rack, and on the lateral shelf in relation to the vertical partitioning board. An insertion hole is disposed on the side of the lateral shelf at where in relation to the vertical partitioning board. A tube plunger internally threaded is fixed into the insertion hole in conjunction with a headed and externally threaded bolt. A notch is disposed at one or four corners of the door panel in relation to the tube plunger. Those door panels on the lowest layer are directly placed on the base while those from other layers are placed by means of their notches on tube plungers partially protruding from their corresponding insertion holes. Each door panel is locked to each sub-rack with the bolt.

The entire arrangement system is made of stone material.

Accordingly, the present invention has all the vertical partitioning boards and lateral partitioning boards or vertical partitioning boards and lateral shelves alternatively abutted to one another in a scientific and reasonable connection to secure a solid and reliable arrangement system. When compared to the prior art, the present invention is more compact in construction with its finished product more solid and firm to give stronger bearing capacity.

When a slate, e.g., granite is selected, the surface of the granite is first ground to deliver a neat, refreshing, and pleasant appearance. The slate is processed as thin as possible, particularly for the slat to be used as the vertical partitioning board, the lateral partitioning board or the backboard, and the lateral shelf to make light-weight finished product, save material consumption, and allow easier packaging, transportation, installation, and use.

Furthermore, for privacy protection, a door panel is provided for each sub-rack in the present invention, so that each sub-rack becomes an independent unit to allow easier access without having to open the dual-decked door as did in the prior art. The individual door panel also saves the material consumption otherwise required by the outer layer of the door panel in one piece.

### BRIEF DESCRIPTION OF THE DRAWINGS

FIG. 1 is a schematic view showing a construction of a cinerary casket arrangement system of the prior art;

FIG. 2 is an exploded view of a preferred embodiment of the present invention;

FIG. 2A is a magnified view of a door panel in FIG. 2;

FIG. 2B is another magnified view of the door panel in FIG. 2;

FIG. 3 is a schematic view of the present invention when assembled;

FIG. 4 is a sectional view of the present invention when assembled;

FIG. 4A is magnified view of a local part taken from FIG. 4; and

FIG. 5 is an exploded view of another preferred embodiment of the present invention.

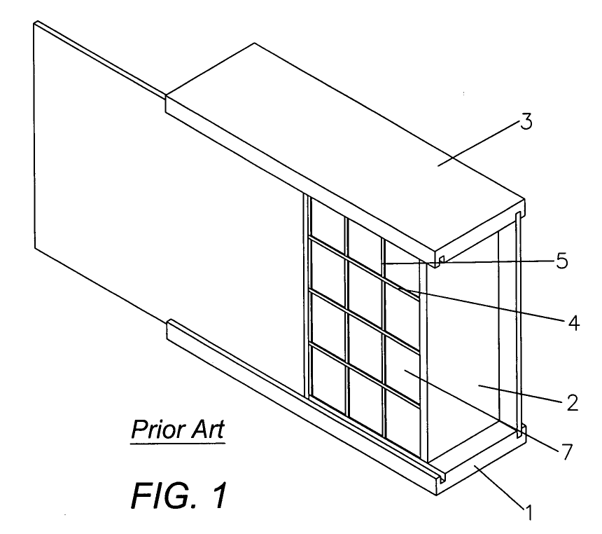

### DETAILED DESCRIPTION OF THE PREFERRED EMBODIMENTS

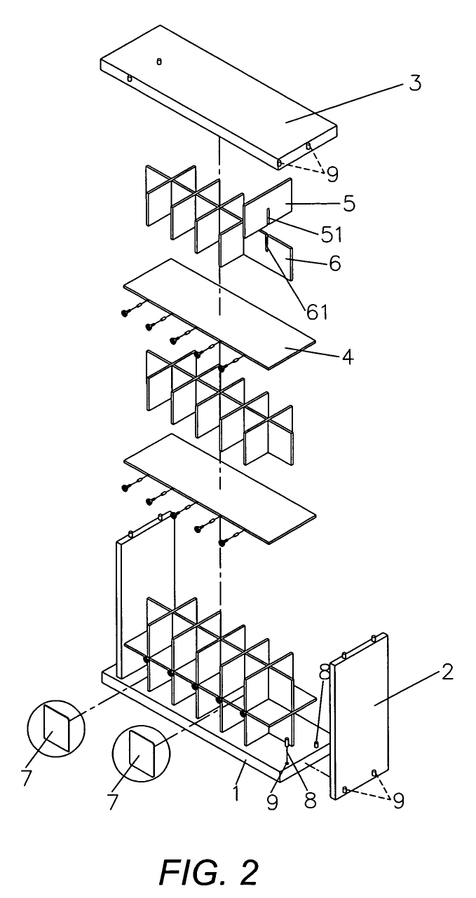

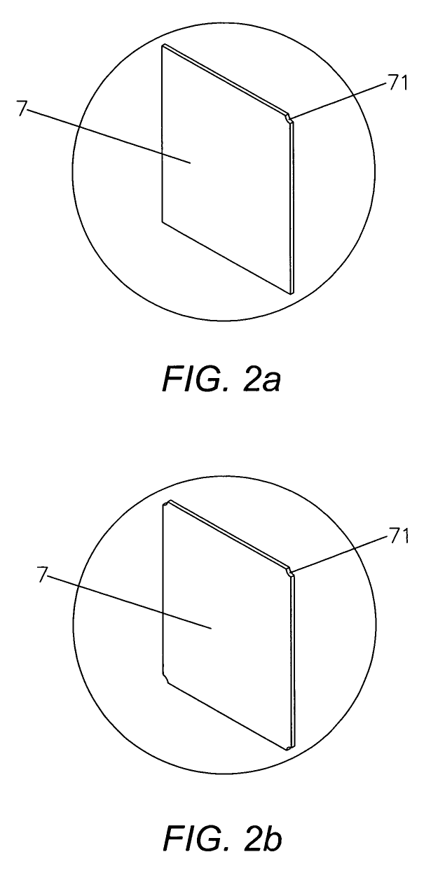

Referring to FIG. 2 for a preferred embodiment of the present invention, a cinerary casket arrangement system allowing access from its front and rear is comprised of a base 1, two sideboards 2, a top 3, multiple lateral shelves 4, vertical partitioning boards 5, multiple lateral partitioning boards 6, and a door panel 7. Wherein, both sideboards 2 are fixed to the base 1 and the top 3. An insertion slot 51 is cut half way at the middle of a long side of each vertical partitioning board 5, and multiple insertion slots 61 in a number equal to that of the vertical partitioning board 5 to be abutted to the lateral partitioning board 6 are provided on one longer side of the lateral partitioning board 6 at where to be abutted to those multiple vertical partitioning boards. Those vertical partitioning boards 5 are alternatively abutted to the lateral partitioning board 6 by inserting their slots 51 into their respective slots 61 to form a layer of multiple sub-racks. The top and bottom edges of each layer comprised of multiple vertical partitioning boards 5 and one lateral partitioning board 6 are respectively fixed to the base 1 and the lateral shelf 4 in case of the lowest layer, to the top 3 and the lateral shelf 4 in case of an upper layer, or sandwiched by two lateral shelves for any intermediate layer with glue, fasteners, or any other means.

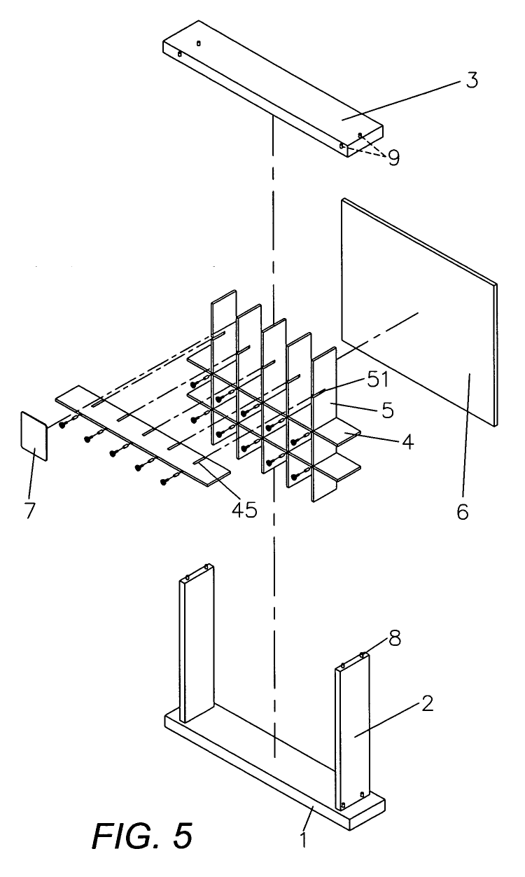

Now referring to FIG. 5 for another preferred embodiment of the present invention, a cinerary casket arrangement system allowing access from the front is comprised of a base 1′, two sideboards 2′, a top 3′, multiple lateral shelves 4′, multiple vertical partitioning boards 5′, a backboard 6′, and multiple door panels 7′. Wherein, the backboard 6′ is fixed to both sideboards 2′, the base 1′, and the top 3′ while both sideboards 2′ are fixed to the base 1′ and the top 3′.

Depending on the number of the lateral shelf 4′ to be abutted to, multiple insertion slots 51′ are disposed on one longer side of each vertical partitioning board 5′; similarly, depending on the number of the vertical partitioning boards 5′ to be abutted to one lateral shelf 4′, multiple insertion slots 45′ are disposed on one longer side of the lateral shelf 4′ at where the longer side meets those insertion slots 51′ on each vertical partitioning board 5′. Multiple vertical partitioning boards 5′ are alternatively abutted to multiple lateral shelves 4′ to form multiple sub-racks. The bottom edge and the top edge of each vertical partitioning board 5′ are respectively fixed to the base 1′ and the top 3′ with both shorter sides of each lateral shelf 4 respectively fixed to both sideboards 2′.

In both preferred embodiments of the present invention described above, both shorter sides of each sideboard 2, 2′ are respectively fixed to the base 1, 1′ and the top 3, 3′ by means of multiple studs 8, 8′ and pinholes 9, 9′, other type of fastener, or other means. For better securing the arrangement system, both shorter sides of the lateral partitioning board 4, 4′ are respectively glued to both sideboards 2, 2′. Multiple pinholes 9, 9′, and two in each of the preferred embodiment, are disposed on the shorter side at the bottom of each sideboard 2, 2′, and another two pinholes 9, 9′ are disposed on each shorter side of the base 1, 1′. The lower end of each stud 8, 8′ is glued in the pinhole 9, 9′ on the base 1, 1′ and the upper end of the stud 8, 8′ is glued to the pinhole 9, 9′ on the sideboard 2, 2′ to firmly secure both sideboard 2, 2′ to the base 1, 1′. Two studs 8, 8′ are disposed on the shorter side at the top of each sideboard 2, 2′, and another two pinholes 9, 9′ are disposed on each shorter side of the top 3, 3′. The lower end of each stud 8, 8′ is glued in the pinhole 9, 9′ on the sideboard 2, 2′ and the upper end of the stud 8, 8′ is glued to the pinhole 9, 9′ on the top 3, 3′ to firmly secure both sideboards 2, 2′ to the top 3, 3′.

When granite slate is selected for the present invention, all the slates are ground and firmly secured to one another in a scientific and reasonable way. When compared to the prior art, the present invention allows easier process, fast assembly, more compact, solid, and reliable construction, stronger bearing capacity, and smooth, delicate, and attractive surface of the finished product to deliver neat, refreshing, and pleasant impression. Each slat may be processed as thin as possible without compromising the design requirements, particularly in case of the vertical partitioning board 5, 5′, the lateral partitioning board 6, the backboard 6′, and the lateral shelf 4, 4′ to make the finished product light, minimize materials consumption, and permit easier packaging, transportation, installation, and use.

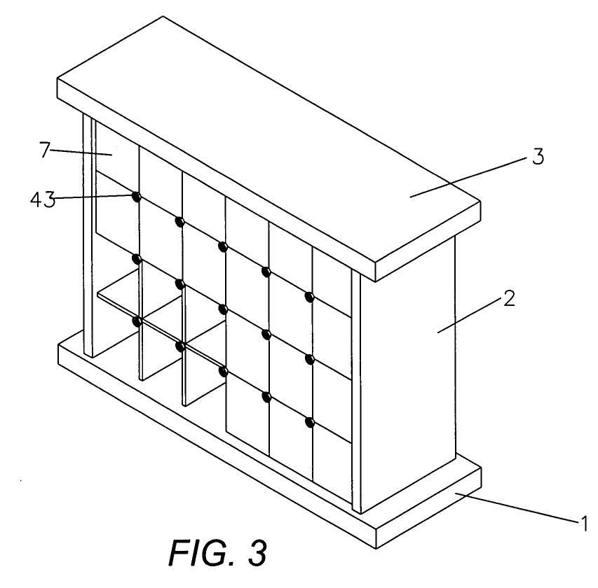

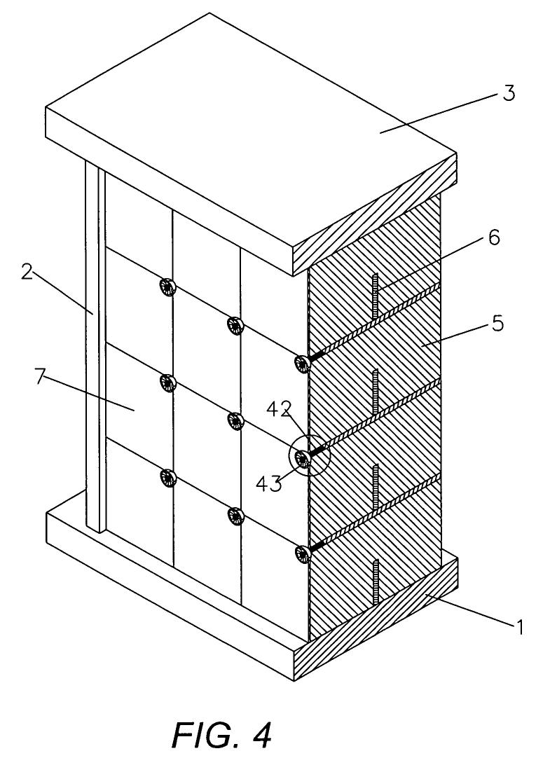

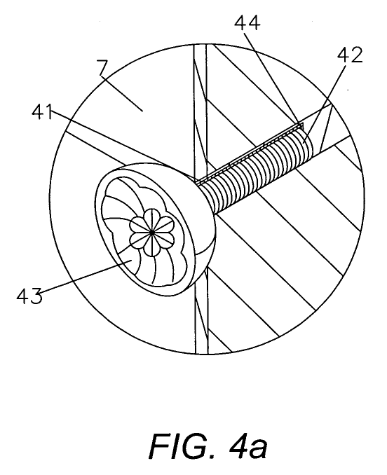

Though a single deck is preferred, the double-decked door panel 7, 7′ of the prior art may be applied the same in the present invention, thus is not illustrated. Each sub-rack is assigned with an individual door panel 7, 7′ in the present invention to make each sub-rack completely standing-alone for privacy protection. As illustrated in FIGS. 2 and 3, multiple insertions holes are disposed on the front edge of each lateral shelf 4, 4′ at where corresponding to the vertical partitioning board 5 is provided. Each insertion hole 41 is glued with an internally threaded tube plunger 44 as illustrated in FIGS. 4, 4A, an externally threaded bolt 42 provided with a head 43 is then inserted and firmly located in the tube plunger 44 by engagement between the internal and external threads respectively from the tube plunger 44 and the bolt 42 to lock the door panel 7, 7′. As illustrated in FIGS. 2A and 2B, a notch 71 is cut at one corner or all four corners of the door panel 7, 7′. The bottom of each door panel 7, 7′ on the lowest layer is forthwith mounted on the base 1, 1′; and the bottom of each door panel 7, 7′ from any other layer is mounted with the notch 71 on the tube plunger 44 protruding from the insertion hole 41 so to prevent the door panel 8 from falling out of position in vertical movement. The top edge of each door panel 7, 7′ on the lowest layer and that on any intermediate layer are also mounted with its notch upon the tube plunger 44 exposed out of the insertion hole 41 and the door panel 7, 7′ is prevented from falling out of position due to lateral movement. Accordingly, each door panel 7, 7′ is firmly locked to the door of each sub-rack. When a certain sub-rack is accessed, it only takes to loosen up the bolt 42 at the door panel 7, 7′ assigned to that sub-rack to remove the door panel 7, 7′ without going through the trouble of opening up the double-decked door panel as did in the prior art while protecting the privacy of any other sub-rack. The individual door panel 7, 7′ designed in the present invention allows easy operation and saves the material otherwise to be consumed by the outer layer of the door panel in the prior art. After the access is completed, restore the door panel 7, 7′ and tighten up the bolt 42.

I claim:

1. A cinerary casket arrangement system including a base, two sideboards, a top, multiple lateral shelves, multiple vertical partitioning boards, multiple lateral partitioning boards, and multiple door panels; both side panels being fixed to the top and the base; an insertion slot being disposed on each vertical partitioning board; multiple insertion slots being disposed on each lateral partitioning board; multiple sub-racks being formed on multiple layers between the top and the lateral shelf, between both lateral shelves, and between the lateral shelf and the base; each layer including multiple vertical partitioning boards being alternatively abutted to one lateral partitioning board by means of the insertion slots; both of the bottom edge and the top edge of those vertical and lateral partitioning boards on each layer being respectively fixed to the base, the lateral shelf, or the top.

2. The cinerary casket arrangement system as claimed in claim 1, wherein both sideboards are fixed to the base and the top by means of studs and pinholes.

3. The cinerary casket arrangement system as claimed in claim 1, wherein multiple pinholes are disposed at each sideboard and the base at where both are fixed to each other; and both ends of a stud are glued into respective pinholes from the sideboard and the base.

4. The cinerary casket arrangement system as claimed in claim 2, wherein multiple pinholes are disposed at each sideboard and the top at where both are fixed to each other; and both ends of a stud are glued into respective pinholes from the sideboard and the top.

5. The cinerary casket arrangement system as claimed in claim 1, wherein each sub-rack is assigned with a single-decked door panel; the front edge of each lateral shelf is disposed with multiple insertion holes in number equal to that of the vertical partitioning boards is abutted to the lateral shelf; an internally threaded tube plunger is secured in the insertion hole; an externally threaded bolt provided with a head is inserted into the tube plunger; one or all four corners of the door panel is provided with a notch, multiple door panels on the lowest layer are directly mounted on the base; each door panel from any other layer are mounted with their notches on the tube plunger protruding from the insertion hole; and each door panel is locked to the door of each sub-rack by means of the bolt.

6. The cinerary casket arrangement system as claimed in claim 1, wherein the base, the top, and all panels and boards are made of stone slates.

7. A cinerary casket arrangement system including a base, two sideboards, a top, multiple lateral shelves, multiple vertical partitioning boards, a backboard, and multiple door panels; the backboard being fixed to both sideboards, the base, and the top; both sideboards being fixed to the base and the top; an insertion slot being disposed on each vertical partitioning board and each lateral shelf; multiple sub-racks being formed by having multiple vertical partitioning boards alternatively abutted to multiple lateral shelves by means of those insertions slots; both of the bottom edge and the top edge of each vertical partitioning board on each layer being respectively fixed to the base and the top; and both shorter sides of each lateral shelf being respectively fixed to both sideboards.

8. The cinerary casket arrangement system as claimed in claim 7, wherein both sideboards are fixed to the base and the top by means of studs and pinholes.

9. The cinerary casket arrangement system as claimed in claim 8, wherein multiple pinholes are disposed at each sideboard and the base at where both are fixed to each other; and both ends of a stud are glued into respective pinholes from the sideboard and the base.

10. The cinerary casket arrangement system as claimed in claim 8, wherein multiple pinholes are disposed at each sideboard and the top at where both are fixed to each other; and both ends of a stud are glued into respective pinholes from the sideboard and the top.

11. The cinerary casket arrangement system as claimed in claim 7, wherein each sub-rack is assigned with a single-decked door panel; the front edge of each lateral shelf is disposed with multiple insertion holes in number equal to that of the vertical partitioning boards is abutted to the lateral shelf; an internally threaded tube plunger is secured in the insertion hole; an externally threaded bolt provided with a head is inserted into the tube plunger; one or all four corners of the door panel is provided with a notch, multiple door panels on the lowest layer are directly mounted on the base; each door panel from any other layer are mounted with their notches on the tube plunger protruding from the insertion hole; and each door panel is locked to the door of each sub-rack by means of the bolt.

12. The cinerary casket arrangement system as claimed in claim 7, wherein the base, the top, and each and all panels and boards are made of stone slates.
